(19) United States
(12) Patent Application Publication
(10) Pub. No.: US 2005/0217192 A1
(43) Pub. Date: Oct. 6, 2005

(54) High end mosaic tile production

(76) Inventor: Moshe Boosy, Walnut Creek, CA (US)

Correspondence Address: Christine A. Lekutis;MEDLEN & CARROLL, LLP, Suite 350, 101 Howard Street, San Francisco, CA, 94105, US

(21) Appl. No.: 10/815,892

(22) Filed: Mar. 31, 2004

(51) Int. Cl. B32B 3/14; E04F 13/00

(52) U.S. Cl. 52/311.1

(57) ABSTRACT

The present invention relates to sheets of mosaic tile, and an apparatus and method of using that apparatus, for their production. In particular, the present invention provides mosaic tile sheets in which the individual mosaic tile subunits are attached to a rigid support such that the finished faces of the mosaic tile subunits are aligned in the same plane (or in the same curved surface).

### FIELD OF THE INVENTION

The present invention relates to sheets of mosaic tile, and an apparatus and method of using that apparatus, for their production. In particular, the present invention provides mosaic tile sheets in which the individual mosaic tile subunits are attached to a rigid support such that the finished faces of the mosaic tile subunits are aligned in the same plane (or in the same curved surface).

### BACKGROUND OF THE INVENTION

Mosaics are pictures or designs made out of small pieces of material (e.g., ceramic, stone, glass, etc.) adhered to a surface. Today, mosaics provide sophisticated decorative work for furnishings, floors, walls, and ceilings. In the home, mosaics are particularly popular surface coverings in the kitchen and bathroom.

One problem in creating tile mosaics is that during installation each mosaic tile must be secured piece-by-piece, in a very time consuming and labor intensive process. In addition to being economically costly, this process creates tremendous logistic problems at the work site, especially when the tile mosaic is installed at or near a main entrance of the building. To reduce the amount of time and labor involved, mosaic tiles are now sometimes pre-mounted in decorative patterns on flexible backing sheets (e.g., paper, mesh, scrim, etc.) of varying sizes (usually matching standard tile sizes), and sold ready to lay in cement. This greatly simplifies the tile setter's work, and was an important factor in the increased popularity of ceramic mosaic tiles.

There are, however, several shortcomings to the use of prefabricated sheets of tile adhered to a flexible backing. In the first place, the flexibility of the backing permits the individual tile units to come in contact with each other, which may lead to breakage of the individual tile units during transport or installation. Moreover, the flexibility of the backing can cause the adhesive layer to become compromised leading to a loss of individual tile units from the sheet.

The inherent unevenness of ceramic tiles poses additional problems, especially when this type of surface is selected as a floor covering. In particular, when individual ceramic tile units are attached to a backing at their back surfaces, the front surfaces of the tiles will not lie in the same plane. Thus, if regulators (such as those disclosed by Lewis in U.S. Pat. No. 6,354,058) are not employed during installation of a mosaic, then the finished front (exterior) surfaces will not be uniform, thereby presenting safety, as well as aesthetic concerns.

Therefore, what is needed in the art, are rigid sheets of mosaic tile with plumb front surfaces, and methods and machines for their production. Rigid sheets of mosaic tile having uniform finished faces not only simplify and make more efficient the commercial installation of mosaics, they are also particularly suitable for installation by amateurs as do-it-yourself projects. A further advantage of this invention is that the edges of the rigid sheets of mosaic tile can be mitered to allow for the treatment of corners (intersecting surfaces that are not co-planar).

### SUMMARY OF THE INVENTION

The present invention relates to sheets of mosaic tile, and an apparatus and method of using the apparatus, for their production. In particular, the present invention provides mosaic tile sheets in which the individual mosaic tile subunits are attached to a rigid support such that the finished faces of the mosaic tile subunits are aligned in the same plane (or in the same curved surface).

The present invention provides an apparatus for producing at least one mosaic tile sheet, comprising: i) a grid comprising a plurality of slots suitable for ordering a plurality of tiles; ii) a screen comprising a plurality of holes corresponding to the plurality of slots of the grid; and iii) a tank comprising an open end and an outlet, wherein when the apparatus is assembled, the screen and the grid cover the open end of the tank. In some preferred embodiments, the apparatus further comprises a vacuum pump connected to the outlet of the tank with tubing, wherein the vacuum pump is suitable for applying negative pressure to the open end of the tank. In additional embodiments, the apparatus further comprises a means to plug the holes of the screen that are not covered by the slots of the grid. In some particularly preferred embodiments, the vacuum pump is rotary vane vacuum pump. In further preferred embodiments, the negative pressure is continuous and invariable. Also provided by the present invention are apparatuses, wherein at least one of the plurality of slots are in a shape selected from the group consisting of a square, a rectangle, a rhombus, a trapezoid, a triangle, a pentagon, a hexagon, an octagon, a circle, an oval, a crescent, and a star. In some preferred embodiments, one or both of the grid and the screen further comprise a means for aligning the screen to the tank and/or the grid to the screen. In some embodiments, the grid is permanently attached to the screen, and/or the screen is permanently attached to the tank.

Moreover, the present invention provides methods for producing at least one mosaic tile sheet, comprising: providing: i) a plurality of mosaic tiles, wherein the tiles comprise front surfaces and back surfaces, ii) an adhesive, iii) a rigid backing comprising a front side and a back side, and iv) an apparatus for producing at least one mosaic tile sheet; placing the plurality of mosaic tiles in the plurality of slots of the grid to produce a grid-mosaic tile assembly; placing the grid-mosaic tile assembly over the screen, wherein one side of the screen covers the open end of the tank, and wherein the opposite side of the screen comes in contact with the front surfaces of the mosaic tiles of the grid-mosaic tile assembly; applying negative pressure to the front surfaces of the mosaic tiles through the holes of the screen with the vacuum pump; and applying the adhesive to a front side of the backing or to the back surfaces of the mosaic tiles, and placing the backing on the grid-mosaic tile assembly such that the back surfaces of the mosaic tiles and the front side of the backing come in contact with the adhesive to produce at least one mosaic tile sheet. In some embodiments, the methods further comprise applying downward pressure to the backing in order to uniformly distribute the adhesive on and around the mosaic tiles of the grid-mosaic tile assembly. In some preferred embodiments, the applying downward pressure does not cause the adhesive to contact the grid. Additional methods further comprise removing the negative pressure after the adhesive has set, and removing the mosaic tile sheet from the apparatus after the negative pressure has been neutralized or removed. In some embodiments, a design template is provided for guiding the placing of the plurality of mosaic tiles. In some preferred embodiments, the methods further comprise beveling at least one side of the mosaic tile sheet.

In addition, the present invention provides mosaic tile sheets produced by the disclosed methods, wherein the mosaic tile sheets comprise a rigid backing, an adhesive and a plurality of tiles, wherein the front surfaces of the mosaic tiles are substantially level. In some embodiments, the rigid backing is made of a material selected from but not limited to ceramic, stone, glass, cultured stone, porcelain, cement, fiber board, resin board, solid plastic, composite material board, wood, and metal. In some embodiments, the adhesive is selected from but not limited to a resin (e.g., epoxy, polyester, vinyl ester, phenolic), cement, thinset, glue, plaster, urethane, acrylic, and hot melt. In further embodiments, the plurality of mosaic tiles comprise at least one of the group consisting of but not limited to a ceramic tile, a glass tile, a stone tile, a cultured stone tile, a porcelain tile, a cement tile, a resin tile, a wood tile, and a plastic tile. In some preferred embodiments, at least one side of the sheet is beveled.

The present invention also provides mosaic tile sheets produced by the disclosed methods, wherein the mosaic tile sheets comprise a rigid backing, an adhesive and a plurality of tiles, wherein the rigid backing is curved, and the front surfaces of the mosaic tiles are substantially at the same height. In some preferred embodiments, the height is measured from the front surface of the backing to the front surfaces of the mosaic tiles. In further embodiments, the mosaic tile sheets comprising a rigid backing, an adhesive and a plurality of mosaic tiles, wherein the front surfaces of the mosaic tiles are substantially even. In some embodiments, the mosaic tiles are substantially even when adjacent mosaic tiles differ in height by preferably less than 2 mm, more preferably less than 1 mm, and most preferably less than 0.5 mm.

### DESCRIPTION OF THE FIGURES

FIG. 1 provides an illustration of one embodiment of the apparatus of the present invention. Panel A provides a representation of the grid, screen, tank, tubing and pump elements of the apparatus. Panel B depicts the proper alignment of the grid and screen.

FIG. 2 provides an illustration of the starting materials and finished product manufactured using one embodiment of the method of the present invention. Panel A depicts the backing, individual mosaic tile subunits and the grid atop a representative design template. Panel B depicts a top view, while panel C depicts a side view of a representative finished product.

FIG. 3 provides a flow chart of the method steps of one embodiment of the present invention.

### DEFINITIONS

To facilitate an understanding of the present invention, a number of terms and phrases are defined below.

As used herein, the term “mosaic” refers to decoration created by setting small pieces of glass, ceramic, stone, marble, etc., in a matrix.

As used herein, the terms “mosaic tile” and “tessera” refer to a small piece of glass, ceramic, stone, marble, etc., used to make a mosaic.

As used herein, the term “tile” refers to a thin (usually between ⅛ inch and 1 inch in thickness) slab of glass, ceramic, stone, marble, cultured stone, or other material, commonly used for application to interior and exterior surfaces of buildings.

As used herein, the term “design template” refers to a diagram of the mosaic that is used as an aid for ordering a plurality of tiles in a grid. In preferred embodiments, the design template comprises a colored sheet that is visible through the slots in the grid and which dictates the color, texture or type of tile to place in each slot of the grid (e.g., red tiles placed in slots covering red areas of the design template, patterned tiles placed in slots covering stippled areas of the design template, etc.).

As used herein, the terms “grid” and “guide” refer to a tool or tools comprising a plurality of slots or voids, for ordering a plurality of mosaic tiles to form a mosaic. The grid of the present invention also stabilizes the mosaic tiles such that the order is preserved until the mosaic tiles are irreversibly attached to a backing.

As used herein, the term “screen” refers to a protective covering that acts as a support, and leveler, and through which a vacuum is applied to the front surfaces of a plurality of tiles through a plurality of holes.

As used herein, the term “tank” refers to a container or vessel through which a vacuum is evenly or substantially evenly applied to mosaic tiles arranged in a grid. In some preferred embodiments, the tank comprises an open end and at least one outlet through which a vacuum is applied.

As used herein, the term “tubing” refers to conduit generally in the form of a hollow (usually cylindrical) object, used to hold and conduct a vacuum from a pump to a tank.

As used herein, the term “pump” refers to a mechanical device that moves gas by, for example, pressure or suction. In preferred embodiments, the pump is a rotary vane vacuum pump for application of a continuous, non-variable negative pressure to the top surfaces of a plurality of tiles. Exemplary pumps include but are not limited to: PVL-71 and PVL-100 pumps manufactured by Travaini Pumps USA (Yorktown, Va.); Dekatorr SA Pumps U4.70 and U4.100 manufactured by Becker Pumps Corporation (Cuyahoga Falls, Ohio); and UVL60 and UVL100 pumps manufactured by Pneumofore SpA (Rivoli, Italy).

As used herein, the terms “vacuum” and “negative pressure” refer to any pressure less than atmospheric or less than room pressure (to the extent that room pressure differs from atmospheric pressure). A perfect vacuum theoretically can occur when the measurement of pressure equals zero. Realistically, however, a perfect vacuum is not attainable. Thus in reference to the present invention the term “vacuum” refers to a partial or incomplete vacuum. In some embodiments, the negative pressure applied to the top surfaces of a plurality of tiles is less than approximately 5 torr. However, the present invention is not limited to a negative pressure up to 5 torr. In fact, the magnitude of the vacuum used with the present invention is contemplated to vary depending upon the size of the desired mosaic tile sheet (with larger sheets potentially requiring a greater negative pressure), and upon the mass of the individual mosaic tile subunits (with heavier mosaic tile subunits potentially requiring a greater negative pressure).

As used herein, the terms “backing” and “substrate” refer to a supportive under-layer. In some embodiments of the present invention, the term “backing” refers to a rigid support such as an unglazed ceramic tile, to which the back surfaces of a plurality of mosaic tiles are irreversibly attached. Other suitable backings include but are not limited to tiles made of stone, glass, cultured stone, porcelain, cement, fiber board, resin board, solid plastic, composite material board, wood, and metal. In some embodiments, the size of the backing (and the mosaic tile sheet) corresponds to a standard tile size (e.g., 1″×6″, 1″×12″, 2″×6″, 2″×12″, 3″×6″, 3″×12″, 4″×6″, 4″×12″, 6″×6″, 6″×12″, 12″×12″, 18″×18″, 24″×24″, etc.). However, in other embodiments, the size of the backing (and of the mosaic tile sheet) corresponds to a nonstandard or even a custom size (special order).

As used herein the terms “gasket” and “plug” refer to means for the blocking of holes in the screen that are not covered by slots and/or mosaic tiles of the grid-mosaic tile assembly.

As used herein, the term “adhesive” refers to a product comprising synthetic or natural material(s) that joins or bonds two items together (e.g., backing and mosaic tile subunits). Drying adhesives (e.g., glue), hot adhesives and reactive adhesives (e.g., epoxy resin) are all suitable for use with the present invention.

As used herein, the term “setting time” refers to the time required for a bond to form, while the term “curing time” refers to the time required for a bond to reach full strength.

As used herein, the term “grout” refers to a thin mortar that can be poured and used to fill the spaces between the individual tessarae of a mosaic or tiles in general.

As used herein, the terms “finished face” “finished surface” and “front surface” refer to the surface of a mosaic tile, which is oriented with and becomes part of the exterior surface of the final product. Conversely, the terms “unfinished surface” and “back surface” refer to the surface of a mosaic tile, which becomes attached to the backing of the final product.

### DESCRIPTION OF THE INVENTION

The present invention relates to sheets of mosaic tile, and an apparatus and method of using that apparatus, for their production. In particular, the present invention provides mosaic tile sheets in which the individual mosaic tile subunits are attached to a rigid support such that the finished faces of the mosaic tile subunits are aligned in the same plane (or in the same curved surface).

I. Apparatus

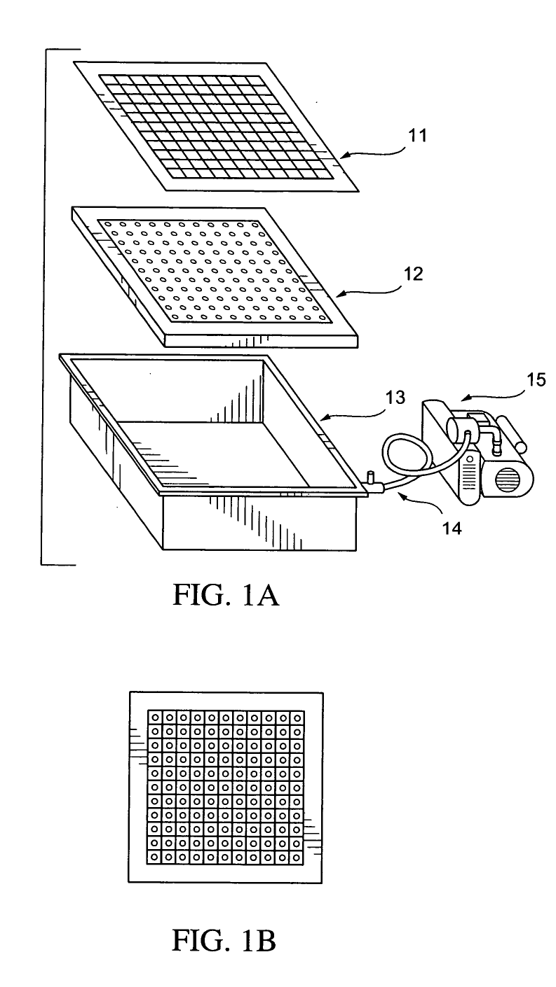

The apparatus of the present invention meets the need in the art for equipment suitable for production of sheets of mosaic tiles in which the finished faces of the individual mosaic tile subunits lie in the same plane. One embodiment of the apparatus is illustrated in panel A of FIG. 1. The apparatus comprises a grid 11 in which individual tile units can be placed either at random or according to a design template on which the grid is placed, to produce a grid-mosaic tile assembly. The grid is made of a rigid material such as metal comprising cut-outs or slots in which the individual tile units are temporarily stabilized before they are attached to a solid substrate or backing. The grid shown in FIG. 1 is designed to hold square tiles, however the grid of the present invention is not limited to this design. In fact, grids comprising diamond, triangular, circular, star-shaped, regular or even irregular cut-outs or slots are encompassed by the present invention.

In addition, in some embodiments, the apparatus comprises a screen 12 element on which the grid-mosaic tile assembly is placed. The screen is also made of a rigid material such as metal. In some preferred embodiments, the screen comprises a multitude of holes corresponding to the openings or cut-outs of the grid 11 element, when the grid is placed on top of the screen, as shown in panel B of FIG. 1. One embodiment of the screen also includes one or more registration fins rising perpendicularly above the surface of the screen that allows the quick and accurate placement of the grid and mosaic tile assembly, so that the exterior faces of the mosaic tiles are properly positioned over the screen holes.

In some embodiments, the apparatus also comprises a tank 13, on which both the screen 12 and grid 11 are placed, either before or after the individual tile units are set in the grid. The tank is preferably made of an inflexible material such as metal, and comprises an opening or port through which negative pressure (vacuum) is applied.

Negative pressure is applied by the use of a vacuum pump 15 via tubing 14 that is, for example, reversibly attached to both the pump and the tank 13. In preferred embodiments, the pump is a rotary vane vacuum pump that applies a continuous, invariable amount of pressure through the screen to the finished-surfaces (top or front) of the individual tile units, in order to place the finished faces of the tiles in the same plane.

In some embodiments, the apparatus also comprises a gasket or gaskets, which may be made of rubber or some other material with similar plugging properties, or individual plugs, which seal(s) the holes not situated under a mosaic tile filled void in the grid 11, when the grid-mosaic tile assembly is smaller than the screen.

While the present invention is principally directed to the production of flat sheets of mosaic tiles, the present invention also comprises the production of curved sheets of mosaic tiles. In particular, the present invention also provides sheets of mosaic tiles suitable for attachment to curved surfaces such as the outside of cylindrical columns or the inside of a semi-circular shower stalls. This is accomplished by the use of an apparatus comprising a curved grid, screen and backing in place of the more-commonly employed flat grid, screen and backing described above. The curved sheets of the present invention mosaic tile are suitable for attachment to cylindrical structures of any radius.

II. Methods

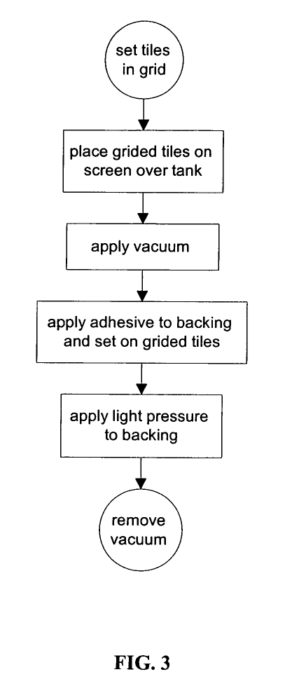

The methods of the present invention meet the need in the art for techniques suitable for production of sheets of mosaic tiles, in which the finished surfaces of the individual tile subunits lie in the same plane or in the same curved surface. An exemplary method is provided in the flowchart of FIG. 3.

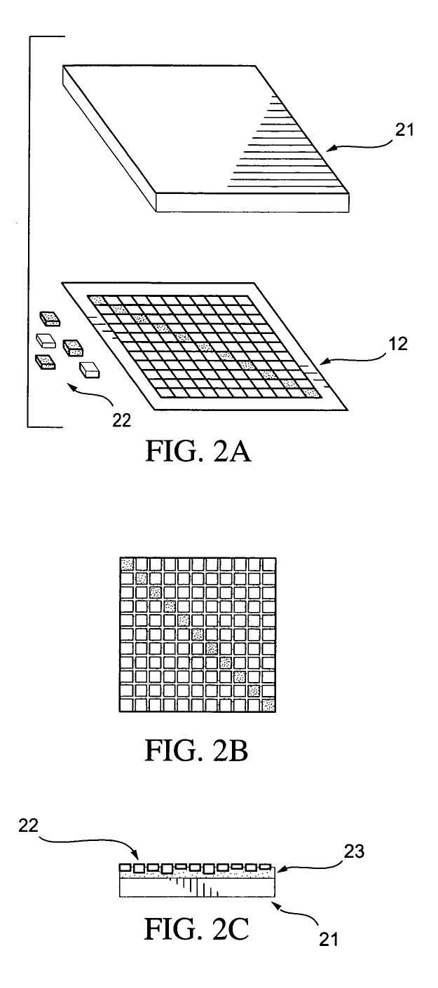

To begin with, a suitable grid 11 is placed either on a work surface or directly on top of a screen 12. Optionally as shown in panel A of FIG. 2 (for intricate patterns), the grid is placed on top of a design template, which provides a color map to assist the user in setting the appropriate colored (or textured) tiles 22 within the grid. For simpler patterns or for the production of a sheet of tiles of the same color, the user simply sets the individual tiles within the grid without the aide of a design template.

The mosaic tiles are then placed into the grid 11 in the pattern chosen, if any, and in accordance with the underlying template, if any. The finished surfaces of the mosaic tiles are placed down into the grid and are registered with the specific surface (usually flat) under the grid. The mosaic tiles are thicker than the grid so that there is a clearance between the rear unfinished surfaces of the mosaic tiles and the back of the grid.

If the tiles were placed in the grid on a separate work surface, then the grid-mosaic tile assembly, is moved to the top of the screen at which time the design template and/or a temporary support is slipped out from under the mosaic tiles without disturbing their placement in the grid. If the screen is not already attached to the tank, the screen-grid-mosaic tile assembly is attached to the tank. The seal between the tank and the screen is airtight.

A vacuum is applied to the top or finished surfaces of the mosaic tiles through the tank and screen, via a suitable pump 15 and tubing 14. This causes the individual mosaic tiles to register with the screen, which causes all finished faces of the mosaic to be leveled in the same plane (or whatever curvature is desired and determined by the design of the screen and matching grid), regardless of what may be varying thicknesses of the different individual mosaic tiles.

An adhesive is applied to a rigid backing 21 and/or to the back, unfinished surfaces of the mosaic tile subunits. The rigid backing is then placed atop the back of the grid-mosaic tile assembly. A light pressure is applied to the backing to level it and to evenly distribute the adhesive under and between the individual tiles of the mosaic. However, due to the clearance between the back of the mosaic tiles and the back of the grid, the adhesive does not come into contact with the back of the grid, and does not attach the grid to the rigid backing. When the adhesive has set, the vacuum is turned off and the grid-mosaic tile assembly is removed from the screen-tank assembly. Then the grid is removed from the finished mosaic sheet comprising a plurality of tiles attached to a backing. The sheets are individually grouted immediately, or grouted with all other mosaic sheets and plain tiles collectively, at the time they are placed in their ultimate application. The former is preferred when stability and uniformity is desired (this prevents the edges or corners of the individual mosaic tiles from being chipped or cracked and prevents individual mosaic tiles from being knocked loose). The latter is preferred when it is critical to match the grout within the mosaic sheets to the grout used between mosaic sheets and/or other standard tiles.

III. Finished Product—Mosaic Sheet

One embodiment of the finished product of the present invention, comprising a mosaic sheet, is illustrated in FIG. 2. Panel B provides a top view of the mosaic sheet showing the uniform spaces between the individual tile units that are grouted during installation. Panel C provides a side view of the mosaic sheet, which comprises a backing 21, an adhesive layer 23, and a plurality of individual tiles 22. The illustration of panel C, clearly indicates that the finished faces of the individual mosaic tile subunits lie in the same plane, even though they are not of a uniform height. This is because, the present invention provides both methods and apparatuses for adhering the individual tiles to a backing, at varying depths, depending upon the differences in the heights of the individual tiles.

The mosaic sheets of the present invention are superior to those of the prior art in that the exterior surfaces of the mosaic tiles are aligned in the same plane (e.g., are perfectly flat), and are permanently fixed in this position. This is of particular importance when the mosaic is used for floor surfaces, where it is especially undesirable to have uneven surfaces in which a high heel or a cane catching on a projecting tile can cause a passerby to trip and fall. Thus, the mosaic sheets of the present invention also make for safe yet decorative flooring. Similarly, the flat surface makes this invention more appealing for application to counter tops where uneven surfaces are also not desirable. In addition, the spaces between the individual tiles are uniform, thus yielding an aesthetically pleasing surface upon installation.

The mosaic sheets of the present invention are superior to those of the prior art in that they can be installed more quickly and simply. The installation compares with that of standard, non-mosaic tiles. In particular, there is no need to level or plumb the individual mosaic tile subunits when the present invention is employed.

Importantly, the present invention is not limited to a single design pattern. In fact, the present invention is suitable for use with any imaginable design, including designs with tiles of different shapes, colors and textures. Examples of suitable designs for mosaic tile sheets of the present invention include but are not limited to the designs shown in FIG. 11 of U.S. Pat. No. 5,568,391 to Mckee (herein incorporated by reference in its entirety).

In some embodiments of the present invention, at least one edge of the mosaic sheet is beveled at an approximately 45-degree angle for proper installation in an area such as around a comer, between a ceiling and a wall, and between a floor and a wall. Before development of the present invention, beveling the edges of pre-fabricated lots of mosaic tiles could not be easily accomplished. This is because the pre-fabricated mosaic sheets of the prior art were typically attached to a flexible backing and therefore could not be sufficiently stabilized for beveling. Thus, the mosaic sheets of the present invention lend themselves to proper installation on angled surfaces.

IV. Computer Aided Design

Additional embodiments of the present invention further comprise the use of computer-aided designs (CADs). In one embodiment, CADs are used to prepare a design template that serves as a guide for the manual placement of tiles within a grid. In other situations, CAD systems are used with the present invention to guide the placement of tiles by an automated or robotic system according to a predetermined pattern (See, e.g., Gerber, U.S. Pat. No. 5,913,992, herein incorporated by reference).

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention, which are obvious to those skilled in the relevant fields, are intended to be within the scope of the following claims.

1. An apparatus for producing at least one mosaic tile sheet, comprising:
i) a grid comprising a plurality of slots suitable for ordering a plurality of tiles;
ii) a screen comprising a plurality of holes corresponding to said plurality of slots of said grid; and
iii) a tank comprising an open end and an outlet, wherein when said apparatus is assembled, said screen and said grid cover said open end of said tank.

2. The apparatus of claim 1, further comprising a vacuum pump connected to said outlet of said tank with tubing, wherein said vacuum pump is suitable for applying negative pressure to said open end of said tank.

3. The apparatus of claim 2, further comprising a means to plug said holes of said screen that are not covered by said slots of said grid.

4. The apparatus of claim 2, wherein said vacuum pump is rotary vane vacuum pump.

5. The apparatus of claim 2, wherein said negative pressure is continuous and invariable.

6. The apparatus of claim 1, wherein at least one of said plurality of slots are in a shape selected from the group consisting of a square, a rectangle, a rhombus, a trapezoid, a triangle, a pentagon, a hexagon, an octagon, a circle, an oval, a crescent, and a star.

7. The apparatus of claim 1, wherein one or both of said grid and said screen further comprise a means for aligning said screen to said tank and/or said grid to said screen.

8. The apparatus of claim 1, wherein said grid is permanently attached to said screen.

9. The apparatus of claim 1, wherein said screen is permanently attached to said tank.

10. A method for producing at least one mosaic tile sheet, comprising:
a) providing:
i) a plurality of mosaic tiles, wherein said tiles comprise front surfaces and back surfaces,
ii) an adhesive,
iii) a rigid backing comprising a front side and a back side, and
iv) the apparatus of claim 2;
b) placing said plurality of mosaic tiles in said plurality of slots of said grid to produce a grid-mosaic tile assembly;
c) placing said grid-mosaic tile assembly over said screen, wherein one side of said screen covers said open end of said tank, and wherein the opposite side of said screen comes in contact with said front surfaces of said mosaic tiles of said grid-mosaic tile assembly;
d) applying negative pressure to said front surfaces of said mosaic-tiles through said holes of said screen with said vacuum pump; and
e) applying said adhesive to a front side of said backing or to said back surfaces of said mosaic tiles, and placing said backing on said grid-mosaic tile assembly such that said back surfaces of said mosaic tiles and said front side of said backing come in contact with said adhesive to produce at least one mosaic tile sheet.

11. The method of claim 10, further comprising step f) applying downward pressure to said backing in order to uniformly distribute said adhesive on and around said mosaic tiles of said grid-mosaic tile assembly.

12. The method of claim 11, wherein said applying downward pressure does not cause said adhesive to contact said grid.

13. The method of claim 11, further comprising step g) removing said negative pressure after said adhesive has set.

14. The method of claim 13, further comprising step h) removing said mosaic tile sheet from said apparatus after said negative pressure has been neutralized.

15. The method of claim 10, wherein a design template is provided for guiding the placing of said plurality of mosaic tiles of step b.

16. The method of claim 14, further comprising step i) beveling at least one side of said mosaic tile sheet.

17. A mosaic tile sheet produced by the method of claim 10, comprising a rigid backing, an adhesive and a plurality of tiles, wherein said front surfaces of said mosaic tiles are substantially level.

18. The mosaic tile sheet of claim 17, wherein said rigid backing is made of a material selected from the group consisting of ceramic, stone, glass, cultured stone, porcelain, cement, fiber board, resin board, solid plastic, composite material board, wood, and metal.

19. The mosaic tile sheet of claim 17, wherein said adhesive is selected from the group consisting of a resin, cement, thinset, glue, plaster, urethane, acrylic, and hot melt.

20. The mosaic tile sheet of claim 17, wherein said plurality of mosaic tiles comprise at least one of the group consisting of a ceramic tile, a glass tile, a stone tile, a cultured stone tile, a porcelain tile, a cement tile, a resin tile, a wood tile, and a plastic tile.

21. The mosaic tile sheet of claim 17, wherein at least one side of said sheet is beveled.

22. A mosaic tile sheet produced by the method of claim 10, comprising a rigid backing, an adhesive and a plurality of tiles, wherein said rigid backing is curved, and said front surfaces of said mosaic tiles are substantially at the same height.

23. The mosaic tile sheet of claim 22, wherein said height is measured from the front surface of said backing to the front surfaces of said mosaic tiles.

24. A mosaic tile sheet comprising a rigid backing, an adhesive and a plurality of mosaic tiles, wherein said front surfaces of said mosaic tiles are substantially even.

25. The mosaic tile sheet of claim 24, wherein said mosaic tiles are substantially even when adjacent mosaic tiles differ in height by less than 2 mm.
